(19) United States
(12) Patent Application Publication
(10) Pub. No.: US 2022/0016790 A1
(43) Pub. Date: Jan. 20, 2022

(54) FOLDING KNIFE WITH BIDIRECTIONAL ACTUATOR

(71) Applicant: Ren-Ten Kustom Knives, LLC, Canon City, CO (US)

(72) Inventor: Robert Edwin Nelson, III, Canon City, CO (US)

(73) Assignee: Ren-Ten Kustom Knives, LLC, Canon City, CO (US)

(21) Appl. No.: 17/365,240

(22) Filed: Jul. 1, 2021

Related U.S. Application Data
(60) Provisional application No. 63/052,024, filed on Jul. 15, 2020.

(51) Int. Cl. B26B 1/04; B26B 1/10

(52) U.S. Cl. CPC B26B 1/042; B26B 1/048; B26B 1/10

(57) ABSTRACT

A bolster-actuated folding knife may have a folding knife blade whose opening and closing is controlled by an actuator on the knife's handle. This bolster-actuator may rotate in either of two rotational directions about the same pivot as the knife blade. When a user rotates the bolster-actuator in one direction, the bolster's pin may impinge via direct contact with the knife blade forcing the knife blade fully open. When a rotates the bolster-actuator in the opposite direction bolster-actuator rotation and thus bolster pin deflection may cause the knife's locking tab to disengage from a cutout in the knife blade, unlocking the knife blade from its fully locked-open position and urging the knife blade to close. Thus, the bolster-actuated folding knife may provide a convenient means to open and close a locking, folding knife with only one hand, and without substantial interference with the knife's aesthetic appeal.

This application is a non-provisional of U.S. Provisional App. Ser. No. 63/052,024, filed Jul. 15, 2020, which is incorporated by reference.

### BACKGROUND

Embodiments of the present invention relate, in general, to hand knives with pivoting knife blades.

### DESCRIPTION OF THE DRAWINGS

FIG. 1A-D are side views (knife laying horizontal) showing the opening of the knife.

FIG. 1E-H are side views (knife laying horizontal) showing the closing of the knife.

FIG. 2A-D are enlarged side views (knife laying vertical) showing the opening of the knife.

FIG. 3A-C are enlarged side views (knife laying vertical) showing the closing of the knife.

FIG. 4 is an exploded perspective view of the knife showing its components.

FIG. 5 is a modified cutaway perspective view of the knife, showing the assembled fit of the knife's components.

FIG. 6 is a planform view of the knife's unassembled components.

FIG. 7A is a side view of a detent-ball/detent combination.

FIG. 7B is a perspective of a detent-ball/detent combination, with the ball suspended above the detent.

FIG. 8 is a side view (knife blade vertical) of one knife blade/locking arm variation.

FIG. 9 is a side view (knife blade vertical) of another knife blade/locking arm variation.

### DESCRIPTION

### Overview

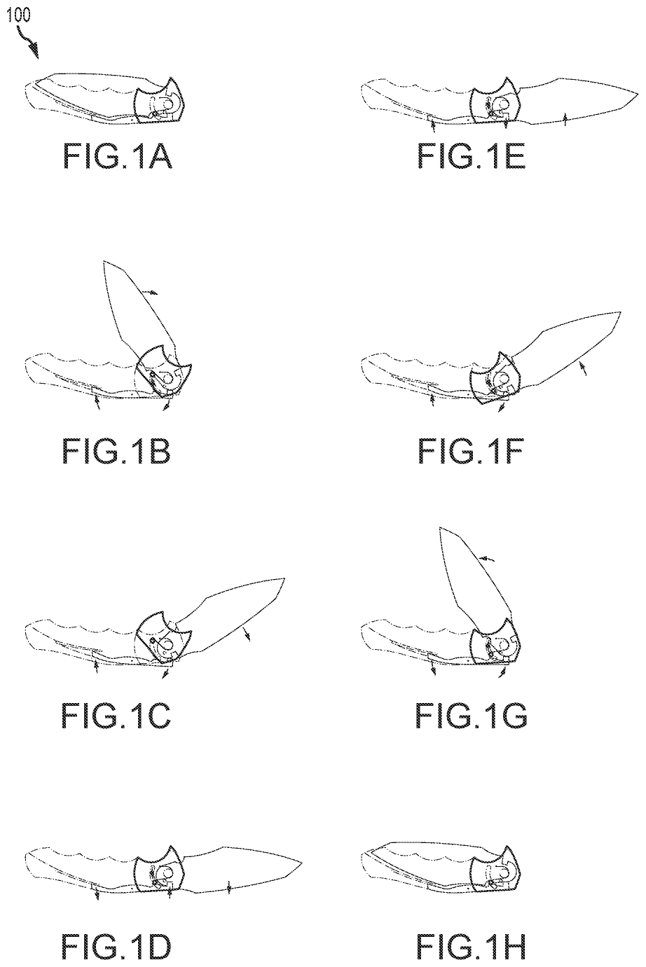

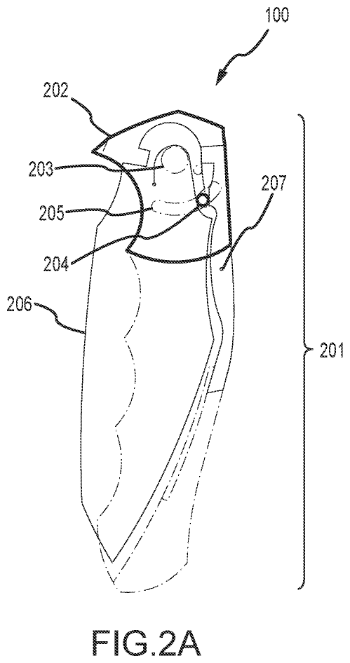

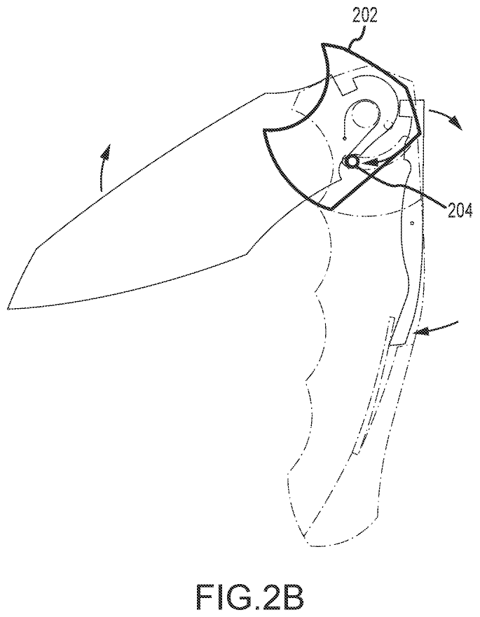

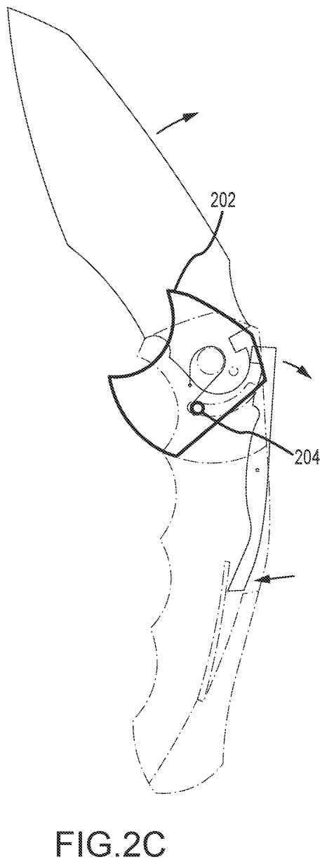

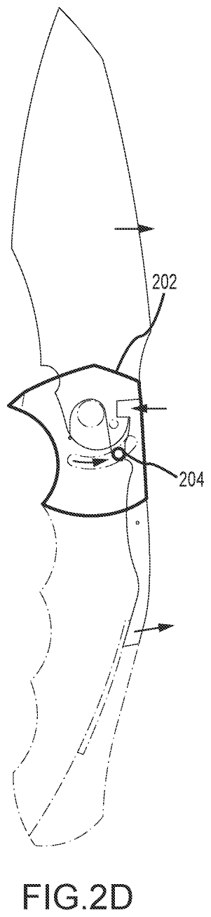

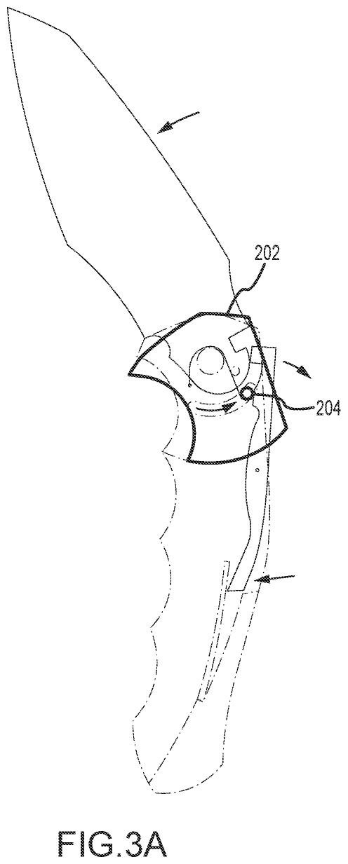

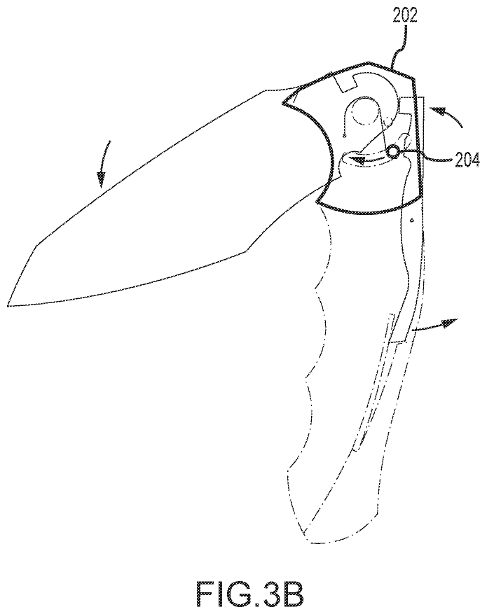

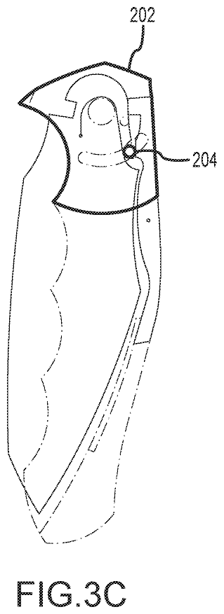

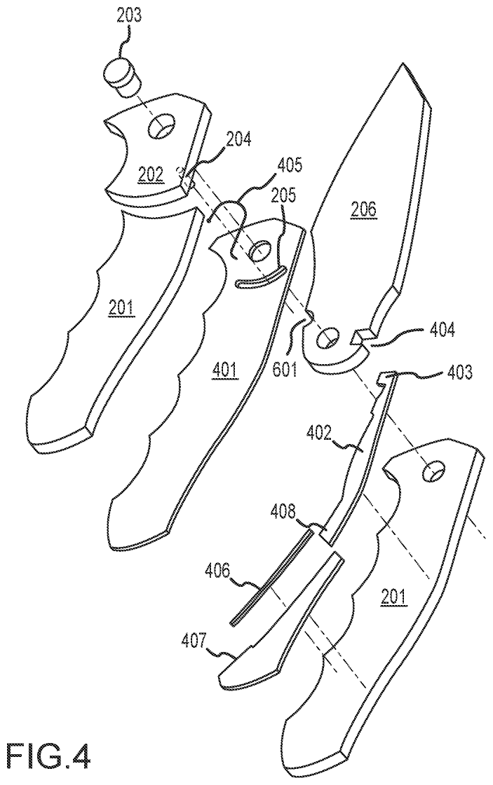

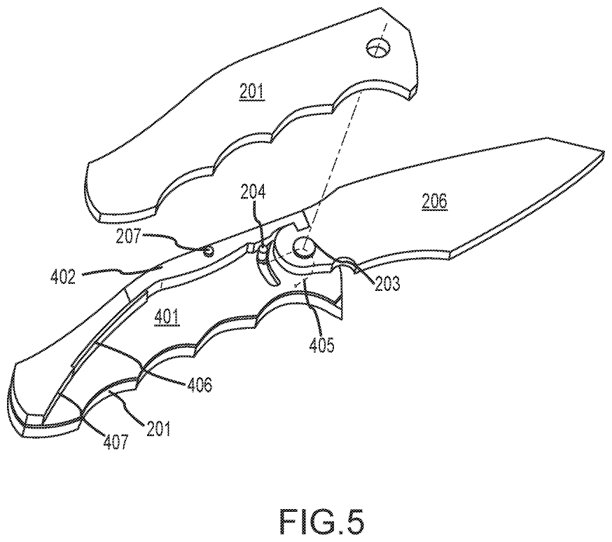

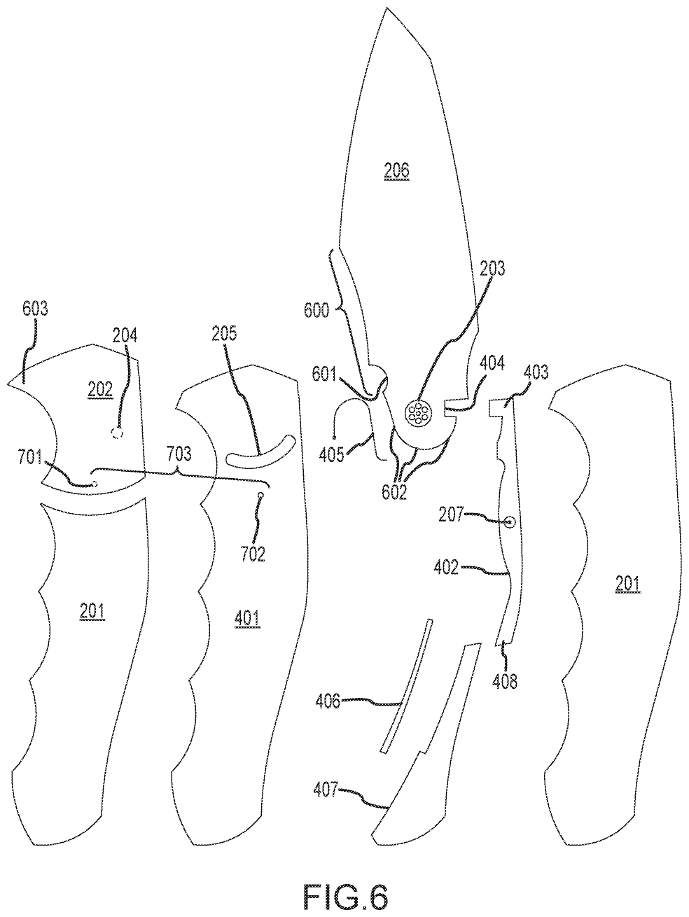

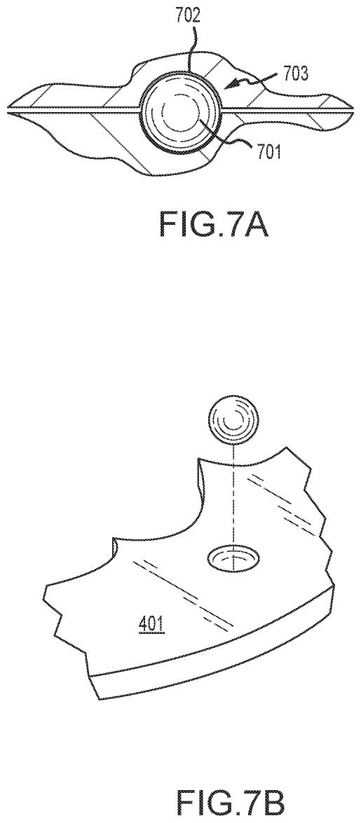

A bolster-actuated folding knife 100 may have a folding knife blade 206 whose opening FIGS. 1A-D, FIGS. 2A-D and closing FIGS. 1E-H, FIGS. 3A-C is controlled by an actuator 202 on the knife's handle 201. The actuator 202 may appear as an ornamental bolster 202 for the knife 100. This bolster-actuator 202 may rotate in either of two rotational directions about the same pivot 203 as the knife blade 206. The knife blade 206 may be rotatably connected to a liner 401 and to the handle 201 at the knife blade pivot 203. The bolster-actuator 202 may have a pin 204 affixed to it that projects inward into the knife body, and travels in a liner slot 205 in the knife's liner 401, with the pin 204 being designed to travel within the curvilinear liner slot 205 in response to actuator 202 rotation. To open the knife 100, starting from when the knife blade 206 is closed, a user rotates the bolster-actuator 202 in one direction FIG. 2B, FIG. 2C, so that the bolster's pin 204 may impinge via direct contact with the knife blade 206, forcing the knife blade 206 to lever fully open FIG. 1D, FIG. 2D about the knife blade pivot 203. To close the knife FIGS. 1E-H, FIGS. 3A-C, starting from when the knife blade 206 is locked open FIG. 2D, a user may rotate the bolster-actuator 202 in the opposite direction FIG. 3A, and that bolster-actuator rotation may cause the bolster's pin 204 to push on the knife's locking arm 402 so that the locking tab 403 disengages from a locking tab cutout 404 in the knife blade 206. That action, in turn, may unlock the knife blade 206 from its fully locked-open position FIG. 1D, FIG. 2D. The locking arm 402 may apply a force FIG. 2B to the knife blade 206 that urges the unlocked knife blade 206 to close by folding into the knife handle 201. Both the pin 204 and liner slot 205 may be concealed from sight in the assembled knife 100. Thus, the bolster-actuated folding knife 100 may provide a convenient means to open and close a locking, folding knife 100 with only one hand, and without substantial interference with the knife's aesthetic appeal.

### Additional Features

The knife 100 may also have other features. For instance, the knife 100 may have a locking arm 402 having a locking tab 403, and the locking arm 402 may be rotatably mounted on a locking arm pivot 207 that extends into the handle 201. The locking arm 402 may be rotatably connected to either or both of the liner 401 and the handle 201 at the locking arm pivot 207. The locking arm 402 may be anchored by a locking arm anchor 407, the locking arm anchor 407 being designed to prevent locking arm 402 rotation of the locking arm foot 408 beyond the knife's spine contours, so that the locking arm foot 408 does not protrude beyond those spine contours to impinge into a user's palm at any point during knife blade 206 opening FIGS. 2A-D or closing FIGS. 3A-C.

Further, the locking arm 402 may be forced by a locking arm spring 406 to apply continual force to the knife blade 206. The locking arm spring 406 may be designed to apply force to the locking arm foot 408, so that through the locking arm pivot 602, that force may be translated to locking tab 403 force upon the knife blade 206. The locking arm pivot 207 may be roughly parallel to the knife blade pivot 203 and the locking tab 403 may be arranged to apply a locking tab force to the knife, so that the applied locking tab force maintains the locking tab 403 in constant contact with the knife blade 206. Designed to mate complementarily with the locking tab 403, a locking tab cutout 404 may be designed into the knife blade 206. The locking tab cutout 404 may thus be designed to accept the locking tab 403 to lock the knife blade 206 when the knife blade 206 is rotated to its opened, locked position FIG. 2D, and designed, in response to actuator pin 204 force on the locking arm 402, to clear the locking tab cutout 404 when the knife blade 206 is rotated from its opened, locked position toward its closed position FIGS. 3A-C.

The knife blade 206 may have a choil 600 and a choil notch 601. The choil notch 601 may be designed to accommodate the actuator pin 204, and the actuator pin 204 may be configured to rotate about the knife blade pivot 203 to contact either or both of the choil notch 601 (or the choil 600 alone, if the choil is designed without a choil notch) or the locking arm 402, depending upon whether the knife blade 206 is being actuated open FIGS. 2A-D; actuated closed FIGS. 3A-C; or the knife 100 is in its fully closed position FIG. 2A, respectively.

The knife 100 may have one or more actuator springs 405, with each actuator spring 405 being designed to apply force on the actuator pin 204 such that the actuator 202 returns to a predetermined position FIG. 2A, FIG. 2D, FIG. 3B, FIG. 3C when external force is removed from the actuator 202.

The knife 100 may have a knife tang 602, and the tang 602 may be cambered such that the locking tab 403 force applied to the cambered knife tang 602 urges the knife 100 into its closed position FIG. 2A when the knife 100 is unlocked from its open, locked position FIG. 2D. The cambering allows the locking tab 403 to follow the cambered contours of the tang 602, so that the locking tab 403 applies a force to the knife tang 602, and the cambering allows the locking tab 403 to “slide” down the cambered tang 602, urging the knife 100 closed as the locking tab 403 forces the tang 602 to rotate as a result of the tang's cambering.

Also, the bolster-actuator 202 may have a protuberance 603 designed to increase actuator moment (as a function of the increased levering distance from the knife blade pivot 203), and thus the force on the knife blade 206 via the actuator pin 204, when force is applied to the protuberance 603.

The knife 100 may have one or more detent balls 701, and each detent ball 701 may be a spherical bearing 701 set into one knife 100 part—for instance, into a knife liner 401—and corresponding to a detent 702 in another knife 100 part, for instance, the bolster-actuator 202. The detent-ball/detent combination 703 may be designed so that a breakaway force is required to displace (or reposition) each detent ball 701 away from its complementary detent 702, so that the breakaway force imparts an increased force to the actuator 202, and thus to the actuator pin 204, when the actuator 202 is actuated, so that the knife blade 206 has enough angular momentum to fully open without stalling in an intermediately-opening position.

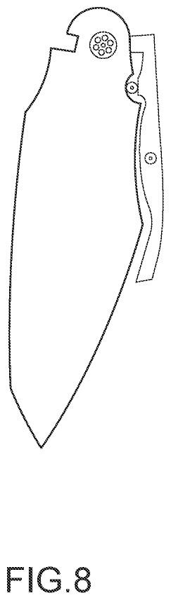

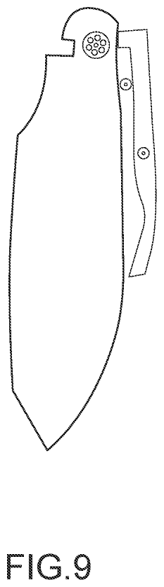

The knife blade 206 and locking arm 402 may also be configured in alternative ways, either with a choil notch FIG. 8 or without FIG. 9, and the locking arm may be designed to accommodate these configurations FIGS. 8-9, permitting the use of a variety of knife blade designs.

### Various Embodiments and Features

In general, the invention may feature a folding knife 100 comprising a handle 201 and a knife blade 206 mounted into the handle 201 via a knife blade pivot 203 near one end of the handle 201. The handle 201 may have a slot to receive the knife blade 206 and the knife blade pivot 203 may support the knife blade 206 through rotational motion between a retracted position within the slot FIG. 2A and an opened, locked position roughly collinear with the handle FIG. 2D. An actuator 202 may be rotatably mounted on the knife blade pivot 203, and the actuator 202 may have an affixed actuator pin 204 and two rotational directions around the knife blade pivot 203. The knife blade 206 is designed to travel in response to actuator 202 rotation, and the actuator pin 204 is designed, in response to rotation of the actuator 204 in one rotational direction FIGS. 2B-D, to apply force to the knife blade 206 to cause the knife blade 206 to travel between its retracted position within the slot FIG. 2A and its opened, locked position FIG. 2D. The actuator 202 is further designed, in response to rotation of the actuator 202 in the opposite rotational direction FIG. 3A, to unlock the knife blade 206 from its opened, locked position FIG. 2D, to enable the knife blade 206 to close FIG. 3C.

The invention may also feature a folding knife 100 comprising a handle 201 and a liner 401 affixed to the handle 201. The liner 401 may have a curvilinear liner slot 205 and the handle 201 may have a handle slot to house a knife blade 206. The folding knife 100 may also have a locking arm 402 having a locking tab 403, the locking arm 402 rotatably connected to either or both of the liner 401 and the handle 201 at a locking arm pivot 207. A knife blade 206 may be mounted into the handle 201 via a knife blade pivot 203 near one end of the handle 201. The knife blade 206 may have an opening direction FIGS. 2A-D and a closing direction FIGS. 3A-C, and the knife blade 206 may be rotatably connected to the liner 401 and to the handle 201 at the knife blade pivot 203. An actuator 202 may be rotatably mounted on the knife blade pivot 203, and the actuator 202 may have a pin 204 affixed to the actuator 202, and the pin 204 may be designed to travel within the curvilinear liner slot 205 in response to actuator 202 rotation. The pin 204 may be designed to apply force to the knife blade 206 when the actuator 202 is rotated in the opening direction FIGS. 2A-D and the pin may be designed to apply force to the locking arm 402 when the actuator 202 is rotated in the closing direction FIG. 3A.

The invention may also feature a method of using a folding knife 100. As with the above aspects, the knife 100 may have a knife handle 201 and an actuator 202, and the actuator 202 may be rotatably mounted on the knife handle 201. Further, in response to rotation by a human being of the actuator 202 on the knife 100, when rotating the actuator 202 in one rotational direction FIGS. 2B-C, the actuator 202, responsive to actuation, may apply force to a knife blade 206 to cause the knife blade 206 to travel between a retracted position FIG. 2A and an opened, locked position FIG. 2D. And when rotating the actuator 202 in the opposite rotational direction FIG. 3A, the actuator 202, responsive to actuation in the opposite rotational direction FIG. 3A, may unlock the knife blade 206 from its opened, locked position FIG. 2D, to enable the knife blade 206 to close.

The invention may include one or more of the following features, and these features may be used singly, or in combination with each other. The folding knife 100 may further comprise one or more detent balls 701, with each detent ball 701 corresponding to a detent 702 and each detent ball 701 being designed to require a breakaway force to reposition each detent ball 701 away from its complementary detent 702, the breakaway force imparting an increased force to the actuator 202, and thus to the actuator pin 204, when the actuator 202 is actuated. The actuator 202 may have a protuberance 603 designed to increase actuator moment, and thus force on the knife blade 206 via the actuator pin 204, when force is applied to the protuberance 603. The folding knife 100 may have a locking arm 402 having a locking tab 403, and the locking arm 402 may be rotatably mounted on a locking arm pivot 207 in the handle 201—the locking arm pivot 207 being roughly parallel to the knife blade pivot 203 and the locking tab 403 arranged to urge a locking tab force to the knife blade 206—and the locking tab force may be applied to keep the locking tab 403 in constant contact with the knife blade 206. The knife blade 206 may have a locking tab cutout 404 in the knife blade 206, and the locking tab cutout 404 may be designed to accept the locking tab 403 to lock the knife blade 206 when the knife blade 206 is rotated to its opened, locked position FIG. 2D. Further, the locking tab 403 may be designed, in response to actuator pin 204 force on the locking arm 402, to clear the locking tab cutout 404 when the knife blade 206 is rotated FIG. 3A from its opened, locked position FIG. 2D. The knife blade 206 may have a choil 600 and the actuator pin 204 may be configured to rotate about the knife blade pivot 203 to contact either or both of the choil 600 or the locking arm 402. The folding knife 100 may further comprise one or more springs 405, and these one or more springs 405 may be designed to apply force on the actuator pin 204 such that the actuator 202 returns to a predetermined position FIG. 2A, FIG. 2D, FIG. 3B, FIG. 3C when external force is removed from the actuator 202. The folding knife 100 may further comprise a knife tang 602 cambered such that the locking tab 403 force applied to the cambered knife tang 602 urges the knife 100 into its closed position FIG. 2A when the knife 100 is unlocked from its open, locked position FIG. 2D. The choil 600 may have a choil notch 601 and the choil notch 601 may be designed to accommodate the actuator pin 204. The folding knife 100 may have one or more detent balls 701, and each detent ball 701 may correspond to a detent 702 and each detent ball 701 may be designed to require a breakaway force to reposition each detent ball 701 away from its complementary detent 702, so that the actuator 202 applies an enhanced force to the actuator pin 204 when actuated. The actuator 202 may have a protuberance 603 designed to enhance actuator 202 force on the knife blade 206 via the actuator pin 204 when force is applied to the protuberance 603. The folding knife 100 may further comprise a locking tab cutout 404 in the knife blade 206, wherein the locking tab 403 may be designed to constantly apply a locking tab force to the knife 100. The locking tab force may keep the locking tab 403 in constant contact with the knife blade 206, and the locking tab cutout 404 may be designed to accept the locking tab 403, locking the knife blade 206 when the knife blade 206 is rotated to its opened, locked position FIG. 2D. The locking tab 403 may be designed, in response to actuator pin 204 force, to clear the locking tab cutout 404 when the knife blade 206 is rotated from its opened, locked position FIG. 2D. The knife blade 206 may have a choil 600 and the actuator pin 204 may be configured to rotate about the knife blade pivot 203 to contact either or both of the choil 600 or the locking arm 402. The folding knife 206 may further comprise one or more actuator springs 405, and the one or more actuator springs 405 may be designed to apply force on the actuator pin 204 such that the actuator 202 returns to a predetermined position FIG. 2A, FIG. 2D, FIG. 3B, FIG. 3C when external force is removed from the actuator 202. The folding knife 100 may further comprise a knife tang 602 cambered such that the locking tab 403 force applied to the cambered knife tang 602 may urge the knife 100 into its closed position FIG. 2A when the knife 100 is unlocked from its open, locked position FIG. 2D. The choil 600 may a choil notch 601 and the choil notch 601 may be designed to accommodate the actuator pin 204. The method may further comprise using one or more detent balls 701, with each detent ball 701 corresponding to a detent 702, and each detent ball 701 being designed to require a breakaway force to reposition each detent ball 701 away from its complementary detent 702, so that the actuator 202 applies an enhanced force when actuated. The method may further comprise rotating the actuator 202 through the use of a protuberance 603 on the actuator, and the protuberance 603 may be designed to enhance actuator force when force is applied to the protuberance 603. The method may further comprise using one or more actuator springs 405 to apply force to the actuator 202 so that the actuator 202 returns to a predetermined position FIG. 2A, FIG. 2D, FIG. 3B, FIG. 3C when external force is removed from the actuator 202.

The above advantages and features are of representative embodiments only and are not all-inclusive. They are presented only to assist in understanding the invention, thus it should be understood that they are not to be considered limitations on the invention as defined by the claims. Novel features and additional advantages of the invention will become apparent from the above description, the drawings, and the claims. Many of these features will also become apparent to those skilled in the art upon examination of the entire specification or may be learned through practice of the invention.

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control.

The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer.

I claim:

1. A folding knife comprising:
a handle and a knife blade mounted into the handle via a knife blade pivot near one end of the handle, the handle having a slot to receive the knife blade and the knife blade pivot supporting the knife blade through rotational motion between a retracted position within the slot and an opened, locked position roughly collinear with the handle;
an actuator, rotatably mounted on the knife blade pivot, the actuator having an affixed actuator pin and two rotational directions around the knife blade pivot and the knife blade being designed to travel in response to actuator rotation, the actuator pin designed:
in response to rotation of the actuator in one rotational direction, to apply force to the knife blade to cause the knife blade to travel between its retracted position within the slot and its opened, locked position, and
in response to rotation of the actuator in the opposite rotational direction, to unlock the knife blade from its opened, locked position, to enable the knife blade to close.

2. The folding knife of claim 1, further comprising:
one or more detent balls, each detent ball corresponding to a detent and each detent ball being designed to require a breakaway force to reposition each detent ball away from its complementary detent, the breakaway force imparting an increased force to the actuator, and thus to the actuator pin, when the actuator is actuated.

3. The folding knife of claim 1, wherein:
the actuator has a protuberance designed to increase actuator moment, and thus force on the knife blade via the actuator pin, when force is applied to the protuberance.

4. The folding knife of claim 1, further comprising:
a locking arm having a locking tab, the locking arm rotatably mounted on a locking arm pivot in the handle, the locking arm pivot being roughly parallel to the knife blade pivot and the locking tab arranged to urge a locking tab force to the knife blade, the locking tab force applied to keep the locking tab in constant contact with the knife blade; and
a locking tab cutout in the knife blade, the locking tab cutout designed to accept the locking tab to lock the knife blade when the knife blade is rotated to its opened, locked position, and designed, in response to actuator pin force on the locking arm, to clear the locking tab cutout when the knife blade is rotated from its opened, locked position.

5. The folding knife of claim 4, wherein:
the knife blade has a choil and the actuator pin is configured to rotate about the knife blade pivot to contact either or both of the choil or the locking arm.

6. The folding knife of claim 4, further comprising:
one or more actuator springs, the one or more actuator springs designed to apply force on the actuator pin such that the actuator returns to a predetermined position when external force is removed from the actuator.

7. The folding knife of claim 4, further comprising:
a knife tang, the knife tang cambered such that the locking tab force applied to the cambered knife tang urges the knife into its closed position when the knife is unlocked from its open, locked position.

8. The folding knife of claim 5, wherein:
the choil has a choil notch and the choil notch is designed to accommodate the actuator pin.

9. A folding knife comprising:
a handle and a liner, the liner affixed to the handle and the liner having a curvilinear liner slot, and the handle having a handle slot to house a knife blade;
a locking arm having a locking tab, the locking arm rotatably connected to either or both of the liner and the handle at a locking arm pivot;
a knife blade mounted into the handle via a knife blade pivot near one end of the handle, the knife blade having an opening direction and a closing direction, and the knife blade being rotatably connected to the liner and to the handle at the knife blade pivot;
an actuator, rotatably mounted on the knife blade pivot, the actuator having a pin affixed to the actuator, and the pin designed to travel within the curvilinear liner slot in response to actuator rotation;
wherein the pin is designed to apply force to the knife blade when the actuator is rotated in the opening direction and wherein the pin is designed to apply force to the locking arm when the actuator is rotated in the closing direction.

10. The folding knife of claim 9, further comprising:
one or more detent balls, each detent ball corresponding to a detent and each detent ball being designed to require a breakaway force to reposition each detent ball away from its complementary detent, so that the actuator applies an enhanced force to the actuator pin when actuated.

11. The folding knife of claim 9, wherein:
the actuator has a protuberance designed to enhance actuator force on the knife blade via the actuator pin when force is applied to the protuberance.

12. The folding knife of claim 9, further comprising a locking tab cutout in the knife blade;
wherein the locking tab is designed to constantly apply a locking tab force to the knife, the locking tab force keeping the locking tab in constant contact with the knife blade, and
wherein the locking tab cutout designed to accept the locking tab, locking the knife blade when the knife blade is rotated to its opened, locked position, and
wherein the locking tab is designed, in response to actuator pin force, to clear the locking tab cutout when the knife blade is rotated from its opened, locked position.

13. The folding knife of claim 12, wherein:
the knife blade has a choil and the actuator pin is configured to rotate about the knife blade pivot to contact either or both of the choil or the locking arm.

14. The folding knife of claim 12, further comprising one or more actuator springs, the one or more actuator springs designed to apply force on the actuator pin such that the actuator returns to a predetermined position when external force is removed from the actuator.

15. The folding knife of claim 12, further comprising a knife tang, the knife tang cambered such that the locking tab force applied to the cambered knife tang urges the knife into its closed position when the knife is unlocked from its open, locked position.

16. The folding knife of claim 13, wherein the choil has a choil notch and the choil notch is designed to accommodate the actuator pin.

17. A method of using a folding knife, the method comprising:
in response to rotation by a human being of an actuator on a knife, the knife having a knife handle and the actuator rotatably mounted on the knife handle, rotating the actuator:
in one rotational direction, the actuator, responsive to actuation, applying force to a knife blade to cause the knife blade to travel between a retracted position and an opened, locked position; and
in the opposite rotational direction, the actuator, responsive to actuation in the opposite rotational direction, unlocking the knife blade from its opened, locked position, to enable the knife blade to close.

18. The method of claim 17, the method further comprising using one or more detent balls, each detent ball corresponding to a detent and each detent ball being designed to require a breakaway force to reposition each detent ball away from its complementary detent, so that the actuator applies an enhanced force when actuated.

19. The method of claim 18, further comprising rotating the actuator through the use of a protuberance on the actuator, the protuberance designed to enhance actuator force when force is applied to the protuberance.

20. The method of claim 19, further comprising using one or more actuator springs to apply force to the actuator so that the actuator returns to a predetermined position when external force is removed from the actuator.
